(19) United States
(12) Patent Application Publication
(10) Pub. No.: US 2025/0038939 A1
(43) Pub. Date: Jan. 30, 2025

(54) METHOD AND DEVICE FOR INDICATING WORKING MODE, METHOD AND DEVICE FOR DETERMINING WORKING MODE, AND COMMUNICATION DEVICE AND STORAGE MEDIUM

(71) Applicant: Beijing Xiaomi Mobile Software Co., Ltd., Beijing (CN)

(72) Inventor: Qun ZHAO, Beijing (CN)

(73) Assignee: Beijing Xiaomi Mobile Software Co., Ltd., Beijing (CN)

(21) Appl. No.: 18/714,129

(22) PCT Filed: Nov. 30, 2021
(86) PCT No.: PCT/CN2021/134665

§ 371 Date: May 29, 2024

(51) Int. Cl. H04L 5/14

(52) U.S. Cl. CPC H04L 5/14

(57) ABSTRACT

A method and device for indicating a working mode, a method and device for determining a working mode, a communication device, and a storage medium. The method for indicating the working mode includes: sending indication information to a network side device for indicating duplex mode information of the terminal to the network side device.

### CROSS-REFERENCE TO RELATED APPLICATIONS

The present disclosure is the U.S. National phase application of International Application No. PCT/CN2021/134665, filed on Nov. 30, 2021, the entire content of which is incorporated herein by reference for all purposes.

### TECHNICAL FILED

The present disclosure relates to the field of communication technology, and specifically, to a method for indicating a working mode, a method for determining a working mode, a device for indicating a working mode, a device for determining a working mode, a communication device and a computer-readable storage medium.

### BACKGROUND

In a current communication system, when a base station communicates with a terminal, the base station supports a full-duplex mode. However, for the terminal, due to its generally smaller size and limited ability to suppress self-interference, it typically only supports a half-duplex mode. But in some cases, it can also achieve the communication in the full-duplex mode.

Although the full-duplex mode can bring benefits such as increased throughput, reduced transmission delay, and enhanced uplink coverage, these benefits are not applicable in all scenarios. Moreover, in some cases, the communication in full-duplex mode may also cause some problems.

### SUMMARY

In view of the above, embodiments of the present disclosure provide a method for indicating a working mode, a method for determining a working mode, a device for indicating a working mode, a device for determining a working mode, a communication device and a computer-readable storage medium, in order to solve technical problems in related art.

According to a first aspect of the embodiments of the present disclosure, a method for indicating a working mode is provided, which is performed by a terminal. The method includes: sending indication information to a network side device for indicating duplex mode information of the terminal to the network side device.

According to a second aspect of the embodiments of the present disclosure, a method for determining a working mode is provided, which is performed by a network side device. The method includes: determining duplex mode information of a terminal according to at least one of the following:
indication information sent by the terminal;
channel state information sent by the terminal;
a power parameter configured for the terminal; or
interference-related information.

According to a third aspect of the embodiments of the present disclosure, a device for indicating a working mode is provided, including one or more processors, wherein the one or more processors are configured to:
send indication information to a network side device for indicating duplex mode information of a terminal to the network side device.

According to a fourth aspect of the embodiments of the present disclosure, a device for determining a working mode is provided, including one or more processors, wherein the one or more processors are configured to determine duplex mode information of a terminal according to at least one of the following:
indication information sent by the terminal;
channel state information sent by the terminal;
a power parameter configured for the terminal; or
interference-related information.

According to a fifth aspect of the embodiments of the present disclosure, a communication device is provided, including: a processor; and memory for storing a computer program which, when executed by the processor, causes the processor to perform the above method for indicating the working mode.

According to a sixth aspect of the embodiments of the present disclosure, a communication device is provided, including: a processor; and memory for storing a computer program which, when executed by the processor, causes the processor to perform the above method for determining the working mode.

According to a seventh aspect of the embodiments of the present disclosure, a non-transitory computer-readable storage medium is provided for storing a computer program which, when executed by a processor, causes the processor to perform the steps in the above method for indicating the working mode.

According to an eighth aspect of the embodiments of the present disclosure, a non-transitory computer-readable storage medium is provided for storing a computer program which, when executed by a processor, causes the processor to perform the steps in the above method for determining the working mode.

### BRIEF DESCRIPTION OF THE DRAWINGS

In order to more clearly illustrate the technical solutions in the embodiments of the present disclosure, the drawings required for the description of the embodiments will be briefly introduced below. Obviously, the drawings described below are merely some of the embodiments of the present disclosure. For those of ordinary skill in the art, other drawings can be obtained based on these drawings without any creative efforts.

FIG. 1 is a schematic flowchart of a method for indicating a working mode according to an embodiment of the present disclosure.

FIG. 2 is a schematic flowchart of another method for indicating a working mode according to an embodiment of the present disclosure.

FIG. 3 is a schematic flowchart of yet another method for indicating a working mode according to an embodiment of the present disclosure.

FIG. 4 is a schematic flowchart of yet another method for indicating a working mode according to an embodiment of the present disclosure.

FIG. 5 is a schematic flowchart of yet another method for indicating a working mode according to an embodiment of the present disclosure.

FIG. 6 is a schematic flowchart of yet another method for indicating a working mode according to an embodiment of the present disclosure.

FIG. 7 is a schematic flowchart of a method for determining a working mode according to an embodiment of the present disclosure.

FIG. 8 is a schematic flowchart of another method for determining a working mode according to an embodiment of the present disclosure.

FIG. 9 is a schematic flowchart of yet another method for determining a working mode according to an embodiment of the present disclosure.

FIG. 10 is a schematic flowchart of yet another method for determining a working mode according to an embodiment of the present disclosure.

FIG. 11 is a schematic block diagram of a device for determining a working mode according to an embodiment of the present disclosure.

FIG. 12 is a schematic block diagram of a device for indicating a working mode according to an embodiment of the present disclosure.

### DETAILED DESCRIPTION

The technical solutions in the embodiments of the present disclosure will be clearly and completely described below with reference to the accompanying drawings in the embodiments of the present disclosure. Obviously, the described embodiments are only some of the embodiments of the present disclosure, rather than all of the embodiments. Based on the embodiments in this disclosure, all other embodiments obtained by those of ordinary skill in the art without any creative efforts will fall within the scope of protection of this disclosure.

The terms used in the embodiments of this disclosure are only for the purpose of describing specific embodiments and are not intended to limit the embodiments of this disclosure. The singular forms of “a/an” and “the” used in the embodiments and the appended claims of this disclosure are also intended to include plural forms unless the context clearly indicates other meanings. It should also be understood that the term “and/or” used herein refers to and includes any or all possible combinations of one or more associated listed items.

It should be understood that although the terms “first,” “second,” and “third,” etc. may be used to describe various information in the embodiments of this disclosure, the information should not be limited by these terms. These terms are only used to distinguish information of the same type from each other. For example, without departing from the scope of the embodiments of this disclosure, the first information may also be referred to as the second information, and similarly, the second information may also be referred to as the first information. Depending on the context, the word “if” as used herein may be interpreted as “at the time of . . . ” or “when . . . ” or “in response to determining . . . ”

For the purpose of brevity and ease of understanding, the terms used herein to characterize size relationships are “greater than” or “less than”, “higher than” or “lower than”. However, it can be understood by those skilled in the art that the term “greater than” also covers the meaning of “greater than or equal to”, and “less than” also covers the meaning of “less than or equal to”, the term “higher than” covers the meaning of “higher than or equal to”, and “lower than” also covers the meaning of “lower than or equal to”.

Although the full-duplex mode can bring benefits such as increased throughput, reduced transmission delay, and enhanced uplink coverage, these benefits are not applicable in all scenarios. Moreover, in some cases, the communication in the full-duplex mode may also cause some problems.

For example, for a base station, the communication based on the full-duplex mode can easily interfere with the uplink transmission of other base stations. For example, for a terminal, the communication based on the full-duplex mode can hardly ensure good communication quality if the terminal has poor self-interference suppression capability.

It can be seen that for base stations and terminals that support the half-duplex mode and the full-duplex mode, always communicating based on the full-duplex mode may cause some technical problems. How to flexibly adjust the duplex mode to adapt to actual situations is the main technical problem solved by the present disclosure.

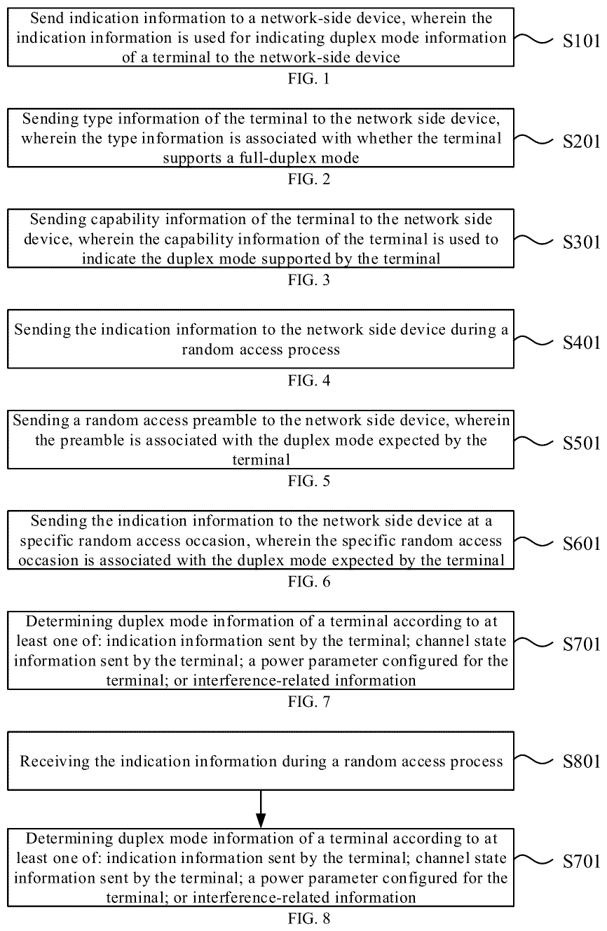

FIG. 1 is a schematic flowchart of a method for indicating a working mode according to an embodiment of the present disclosure. The method for indicating the working mode shown in this embodiment may be performed by a terminal, which includes but is not limited to a mobile phone, a tablet computer, a wearable device, a sensor, an Internet of Things device and other communication devices. The terminal can communicate with a network side device, which includes but is not limited to a network side device in 4G, 5G, 6G, or other communication systems, such as a base station, a core network, etc.

As shown in FIG. 1, the method for indicating the working mode may include the following step:
S101, sending indication information to a network side device for indicating duplex mode information of the terminal to the network side device.

In one embodiment, the terminal may send indication information to the network side device. The network side device may determine the duplex mode of the terminal based on the indication information.

In one embodiment, the duplex mode information of the terminal includes at least one of the following:
a duplex mode supported by the terminal;
a duplex mode expected to be adopted for scheduling the terminal by the network side device; or
a duplex mode expected to be adopted by the network side device.

In one embodiment, the duplex mode includes at least a half-duplex mode and a full-duplex mode. The full-duplex mode refers to performing uplink transmission and downlink transmission simultaneously in the same frequency domain resource(s).

For example, for a network side device, the full-duplex mode means that uplink reception and downlink transmission are performed simultaneously in the same frequency domain resource(s), such as the same slot, wherein the uplink reception and downlink transmission can be performed for different terminals or for the same terminal.

For example, for a terminal, the full-duplex mode means that uplink transmission and downlink reception are performed simultaneously in the same frequency domain resource(s), such as the same slot, wherein the slot includes at least one of the following: a downlink slot in a Time Division Duplexing (TDD) frequency band, an uplink slot in a TDD frequency band, or a slot in a Frequency Division Duplexing (FDD) frequency band.

In addition, for a network side device, the full-duplex mode may include Subband-Based Full Duplex (SBFD) and Shared Spectrum Full Duplex (SSFD). SBFD can be further divided into two full-duplex modes, i.e., Non-overlapping subband and Partial overlapping subband.

In one embodiment, based on the indication information sent by the terminal, the network side device can determine the duplex mode supported by the terminal. For example, it can be determined that the terminal only supports the half-duplex mode, or only supports the full-duplex mode, or supports both the half-duplex mode and the full-duplex mode.

Based on this, the network side device can determine which duplex mode can be adopted subsequently for scheduling the terminal.

In one embodiment, based on the indication information sent by the terminal, the network side device can determine the duplex mode expected by the terminal to be adopted for scheduling the terminal by the network side device. For example, when the terminal supports both the half-duplex mode and the full-duplex mode, the duplex mode that the terminal expects the network side device to adopt for scheduling the terminal, may be only the half-duplex mode, or only the full-duplex mode, or either the full-duplex mode or the half-duplex mode.

Based on this, the network side device can determine which duplex mode needs to be adopted subsequently for scheduling the terminal.

The duplex mode supported by the terminal includes a duplex mode expected to be adopted for scheduling the terminal by the network side device, that is, the terminal does not expect the network side device to schedule the terminal to adopt a duplex mode that the terminal does not support.

In one embodiment, based on the indication information sent by the terminal, the network side device can determine the duplex mode excepted by the terminal to be adopted by the network side device, for example, the terminal expects the network side to adopt the full-duplex mode, or the half-duplex mode, or either the full-duplex mode or the half-duplex mode.

Based on this, the network side device can determine which duplex mode it needs to adopt subsequently. Of course, the actual duplex mode adopted by the network side device subsequently may be different from the duplex mode that the terminal expects the network side device to adopt. The specific duplex mode can be determined by the network side device according to needs. However, when either the full-duplex mode or the half-duplex mode can be adopted, the duplex mode that the terminal expects the network side device to adopt can be preferentially adopted to meet the needs of the terminal.

According to the embodiments of the present disclosure, the terminal can send indication information to the network side device so that the network side device can know the duplex mode information of the terminal to subsequently schedule the terminal to adopt an appropriate duplex mode according to actual situations, thereby avoiding problems caused by the duplex mode adopted by the terminal not matching the actual situations.

In one embodiment, if the network side device does not determine whether the terminal supports the full-duplex mode, the network device may only schedule the terminal to adopt the half-duplex mode when scheduling the terminal to adopt a duplex mode. For example, for a certain time slot, the network device may only schedule the terminal to perform uplink transmission on that time slot, or downlink reception on that time slot, in order to avoid communication problems caused by scheduling the terminal to adopt the full-duplex mode when the terminal does not support full-duplex mode.

In one embodiment, the indication information sent by the terminal to the network side device may be explicit indication information or implicit indication information. The following exemplifies the explicit indication and implicit indication through several embodiments.

FIG. 2 is a schematic flowchart of another method for indicating a working mode according to an embodiment of the present disclosure. As shown in FIG. 2, the duplex mode information of the terminal includes the duplex mode supported by the terminal, and sending the indication information to the network side device includes the following step:
S201, sending type information of the terminal to the network side device, wherein the type information is associated with whether the terminal supports a full-duplex mode.

In one embodiment, the terminal may report its own type information to the network side device, wherein the network side device may pre-store the association relationship(s) between the terminal's type information and whether the terminal supports the full-duplex mode. Then, it can be determined whether the terminal supports the full-duplex mode according to the terminal's type information.

For example, type A is associated with the terminal supporting the full-duplex mode, and type B is associated with the terminal not supporting the full-duplex mode. When the indication information received by the network side device is type A, it can be determined that the terminal supports the full-duplex mode. When the indication information received is type B, it can be determined that the terminal does not support the full-duplex mode.

Based on this approach, the terminal can implicitly indicate to the network side device whether the terminal supports the full-duplex mode by reporting the type information of the terminal to the network side device.

FIG. 3 is a schematic flowchart of yet another method for indicating a working mode according to an embodiment of the present disclosure. As shown in FIG. 3, the duplex mode information of the terminal includes the duplex mode supported by the terminal, and sending the indication information to the network side device includes the following step:
S301, sending capability information of the terminal to the network side device, wherein the capability information of the terminal is used to indicate the duplex mode supported by the terminal.

In one embodiment, the terminal can explicitly indicate to the network side device the duplex mode supported by the terminal. For example, the capability information can be that the terminal only supports the half-duplex mode, or the terminal only supports the full-duplex mode, or the terminal supports both the half-duplex mode and the full-duplex mode. In addition to this indication method, the terminal can be defaulted to support the half-duplex mode, and on this basis, the capability information indicates whether the terminal supports the full-duplex mode or not.

FIG. 4 is a schematic flowchart of yet another method for indicating a working mode according to an embodiment of the present disclosure. As shown in FIG. 4, the duplex mode information of the terminal includes the duplex mode expected to be adopted for scheduling the terminal by the network side device, and sending the indication information to the network side device includes the following step:
S401, sending the indication information to the network side device during a random access process.

In one embodiment, the terminal may send the indication information to the network side device on appropriate resources as needed. For example, the terminal may send the indication information to the network side device during the random access process. Accordingly, it can be ensured that the network side device can determine the duplex mode information of the terminal during the random access process, so that after the subsequent communication connection is established, the terminal can be scheduled to adopt the appropriate duplex mode as soon as possible, or the duplex mode expected by the terminal can be adopted as soon as possible.

FIG. 5 is a schematic flowchart of yet another method for indicating a working mode according to an embodiment of the present disclosure. As shown in FIG. 5, sending the indication information to the network side device during the random access process includes the following step:
S501, sending a random access preamble to the network side device, wherein the preamble is associated with the duplex mode expected by the terminal.

In one embodiment, the terminal and the network side device may pre-store a first association relationship between a preamble (e.g., a preamble index) and a duplex mode expected by the terminal. After the duplex mode expected by the terminal is determined, the preamble corresponding to the duplex mode expected by the terminal can be determined according to the first association relationship, and then the determined preamble is sent to the network side device. After receiving the preamble sent by the terminal, the network side device can determine the duplex mode expected by the terminal corresponding to the preamble according to the first association relationship.

FIG. 6 is a schematic flowchart of yet another method for indicating a working mode according to an embodiment of the present disclosure. As shown in FIG. 6, sending the indication information to the network side device during the random access process includes the following step:
S601, sending the indication information to the network side device at a specific random access occasion (RO), wherein the specific random access occasion is associated with the duplex mode expected by the terminal.

In one embodiment, the terminal and the network side device may pre-store a second association relationship between a random access occasion and a duplex mode expected by the terminal. After the duplex mode expected by the terminal is determined, the specific random access occasion corresponding to the duplex mode expected by the terminal can be determined according to the second association relationship, and then the indication information is sent to the network side device at the specific random access occasion. For example, a random access message serves as the indication information. The network side device receives the random access message sent by the terminal at the specific random access occasion, and can determine the duplex mode expected by the terminal corresponding to the specific random access occasion according to the second association relationship.

In one embodiment, sending the indication information to the network side device during the random access process includes: sending a random access message Msg3 or MsgA to the network side device, wherein the random access message carries information associated with the duplex mode expected by the terminal.

During a four-step random access process, the terminal may carry indication information in the random access message Msg3 and send it to the network side device. During a two-step random access process, the terminal may carry indication information in the random access message MsgA and send it to the network side device.

FIG. 7 is a schematic flowchart of a method for determining a working mode according to an embodiment of the present disclosure. The method for determining the working mode shown in this embodiment may be performed by a network side device which includes but is not limited to a network side device in 4G, 5G, 6G and other communication systems, such as a base station, a core network, etc. The network side device can communicate with a terminal which includes but is not limited to a mobile phone, a tablet computer, a wearable device, a sensor, an Internet of Things device and other communication devices.

As shown in FIG. 7, the method for determining the working mode may include the following step:
S701, determining duplex mode information of a terminal according to at least one of the following:
indication information sent by the terminal;
Channel State Information (CSI) sent by the terminal;
a power parameter configured for the terminal; or
interference-related information.

In one embodiment, the duplex mode information of the terminal includes at least one of the following:
a duplex mode supported by the terminal;
a duplex mode expected by the terminal to be adopted for scheduling the terminal by the network side device; or
a duplex mode expected by the terminal to be adopted by the network side device.

It should be noted that, in addition to determining the duplex mode information of the terminal, the network side device can also determine the duplex mode that the network side device itself needs to adopt.

In one embodiment, the terminal may send indication information to the network side device, and based on the indication information, the network side device may determine the duplex mode of the terminal.

In one embodiment, the duplex mode includes at least a half-duplex mode and a full-duplex mode. The full-duplex mode refers to performing uplink transmission and downlink transmission simultaneously in the same frequency domain resource(s).

For example, for a network side device, the full-duplex mode means that uplink reception and downlink transmission are performed simultaneously in the same frequency domain resource(s), such as the same slot, wherein the uplink reception and downlink transmission can be performed for different terminals or for the same terminal.

For example, for a terminal, the full-duplex mode means that uplink transmission and downlink reception are performed simultaneously in the same frequency domain resource(s), such as the same slot, wherein the slot includes at least one of the following: a downlink slot in a Time Division Duplexing (TDD) frequency band, an uplink slot in a TDD frequency band, or a slot in a Frequency Division Duplexing (FDD) frequency band.

In addition, for a network side device, the full-duplex mode may include Subband-Based Full Duplex (SBFD) and Shared Spectrum Full Duplex (SSFD). SBFD can be further divided into two full-duplex modes, i.e., Non-overlapping subband and Partial overlapping subband.

In one embodiment, based on the indication information sent by the terminal, the network side device can determine the duplex mode supported by the terminal. For example, it can be determined that the terminal only supports the half-duplex mode, or only supports the full-duplex mode, or supports both the half-duplex mode and the full-duplex mode.

Based on this, the network side device can determine which duplex mode can be adopted subsequently for scheduling the terminal.

In one embodiment, based on the indication information sent by the terminal, the network side device can determine the duplex mode expected by the terminal to be adopted for scheduling the terminal by the network side device. For example, when the terminal supports both the half-duplex mode and the full-duplex mode, the duplex mode that the terminal expects the network side device to adopt for scheduling the terminal, may be only the half-duplex mode, or only the full-duplex mode, or either the full-duplex mode or the half-duplex mode.

Based on this, the network side device can determine which duplex mode needs to be adopted subsequently for scheduling the terminal.

The duplex mode supported by the terminal includes a duplex mode expected to be adopted for scheduling the terminal by the network side device, that is, the terminal does not expect the network side device to schedule the terminal to adopt a duplex mode that the terminal does not support.

In one embodiment, based on the indication information sent by the terminal, the network side device can determine the duplex mode expected by the terminal to be adopted by the network side device, for example, the terminal expects the network side to adopt the full-duplex mode, or the half-duplex mode, or either the full-duplex mode or the half-duplex mode.

Based on this, the network side device can determine which duplex mode it needs to adopt subsequently. Of course, the actual duplex mode adopted by the network side device subsequently may be different from the duplex mode that the terminal expects the network side device to adopt. The specific duplex mode can be determined by the network side device according to needs. However, when either the full-duplex mode or the half-duplex mode can be adopted, the duplex mode that the terminal expects the network side device to adopt can be preferentially adopted to meet the needs of the terminal.

In one embodiment, in addition to determining the duplex mode information of the terminal based on the indication information sent by the terminal, the network side device can also determine the duplex mode information of the terminal based on the CSI reported by the terminal, or based on the power parameter(s) configured for the terminal. The duplex mode information of the terminal can also be determined based on the interference-related information.

In one embodiment, the CSI reported by the terminal to the network side device can be obtained based on a Reference Signal (RS). The RS may be an existing RS, including but not limited to Aperiodic CSI RS, Periodic CSI RS, or semi-persistent CSI RS. The RS may also be a dedicated CSI RS, such as a CSI RS of the CSI dedicated to determining the duplex mode information of the terminal. The dedicated CSI RS can be periodic, aperiodic, semi-persistent, or based on subbands or bandwidths.

The network side device may determine the current channel quality based on the CSI reported by the terminal. If the current channel quality is relatively poor, the terminal can be scheduled to adopt the half-duplex mode.

In one embodiment, the network side device may configure the power parameter(s) for the terminal, including but not limited to an initial power P0, a dynamic power adjustment parameter, etc. P0 can be adjusted through the dynamic power adjustment parameter. The network side can determine the current transmission power of the terminal based on P0 and the dynamic power adjustment parameter.

When the transmission power is high, cross-slot interference becomes more serious and the communication effect in full-duplex mode is poor. In this case, the network side device can determine that the duplex mode that the terminal is scheduled to adopt is the half-duplex mode if it determines, based on the power parameter, that the transmission power of the terminal is relatively high, in order to avoid strong cross-slot interference and ensure good communication quality. If the network side device determines, based on the power parameter, that the transmission power of the terminal is relatively low, it can determine that the duplex mode that the terminal is scheduled to adopt is the full-duplex mode, in order to improve communication efficiency in the case of weak cross-slot interference.

In one embodiment, the interference-related information includes at least one of the following:
a transmission power of the network side device;
an antenna configuration of the network side device; or
interference measurement information.

In one embodiment, the network side device can determine the network interference situation based on the interference-related information. When the network interference is relatively weak, it can be determined that the duplex mode that the terminal is scheduled to adopt is the full-duplex mode, and it can also be determined that the duplex mode that the network side device itself needs to adopt is the full-duplex mode. When the network interference is relatively strong, it can be determined that the duplex mode that the terminal is scheduled to adopt is the half-duplex mode, and it can also be determined that the duplex mode that the network side device itself needs to adopt is the half-duplex mode.

In one embodiment, the network side device can determine the interference to other network side devices based on its own transmission power. For example, when the transmission power of the network side device is relatively low (for example, lower than a preset power threshold), it can be determined that the interference caused by the downlink transmission of the network side device to the uplink reception of other network side devices is within a controllable range, and then it can be determined that the duplex mode adopted by the network side device itself is full-duplex mode. For example, when the transmission power of the network side device is relatively high (for example, higher than a preset power threshold), it can be determined that the interference caused by the downlink transmission of the network side device to the uplink reception of other network side devices is uncontrollable, and then it can be determined that the duplex mode adopted by the network side device itself is half-duplex mode.

In one embodiment, the network side device can determine the self-interference isolation degree according to its own antenna configuration. For example, if the antenna configuration has a relatively large number of available antennas (for example, greater than a preset number threshold), it can be determined that the self-interference isolation degree is high and the ability to suppress self-interference is strong. Therefore, it can be determined that the duplex mode adopted by the network side device itself is full-duplex mode. For example, if the antenna configuration has a relatively small number of available antennas (for example, less than a preset number threshold), it can be determined that the self-interference isolation degree is low and the ability to suppress self-interference is weak. Therefore, it can be determined that the duplex mode adopted by the network side device itself is half-duplex mode.

In one embodiment, the network side device can also obtain interference measurement information, such as the CSI reported by the terminal. When it is determined that the interference in the current network is relatively small based on the interference measurement information, it can be determined that the duplex mode adopted by the network side device itself is full duplex mode. When it is determined that the interference in the current network is relatively large based on the interference measurement information, it can be determined that the duplex mode adopted by the network side device itself is half-duplex mode.

It should be noted that the duplex mode to be adopted by the scheduled terminal and determined by the network side device, may or may not be associated with the duplex mode adopted by the network side device itself and determined by the network side device, which can be set as desired.

For example, the network side device can separately determine the duplex mode to be adopted by the scheduled terminal and the duplex mode adopted by the network side itself. There is no correlation between the duplex modes adopted by the terminal and the network side device.

For example, the network side device can determine the duplex mode adopted by the network side device itself based on the duplex mode to be adopted by the scheduled terminal. For example, it is determined that the scheduled terminal adopts the full-duplex mode, and based on this, it can be determined that the network side device adopts the full-duplex mode, or the network side device adopts the half-duplex mode.

For example, the network side device can determine the duplex mode to be adopted by the scheduled terminal based on the duplex mode adopted by the network side device itself. For example, it is determined that the network side device adopts the full-duplex mode, and based on this, it can be determined that the duplex mode to be adopted by the scheduled terminal is the full-duplex mode, or the duplex mode to be adopted by the scheduled terminal is the half-duplex mode.

According to the embodiments of the present disclosure, the network side device can determine the information such as the duplex mode information of the terminal and the duplex mode adopted by the network side device itself, based on the indication information sent by the terminal, the reported CSI, the power parameter configured for the terminal, the interference-related information, etc. In this way, the network side device can know the duplex mode information of the terminal and determine the duplex mode adopted by the network side device itself. Subsequently, the network side device can schedule the terminal to adopt an appropriate duplex mode according to actual situations, and adopt an appropriate duplex mode itself, thereby avoiding problems caused by the duplex mode adopted by the terminal or the network side device not matching the actual situations.

In one embodiment, if the network side device does not determine whether the terminal supports full-duplex mode, the network side device only schedules the terminal to adopt the half-duplex mode when scheduling the terminal to adopt a duplex mode. For example, for a certain slot, the network device may only schedule the terminal to perform uplink transmission on that time slot, or downlink reception on that time slot, in order to avoid communication problems caused by scheduling the terminal to adopt the full-duplex mode when the terminal does not support full-duplex mode.

In one embodiment, the duplex mode information of the terminal includes the duplex mode supported by the terminal, and the indication information includes at least one of the following:
type information of the terminal, wherein the type information is associated with whether the terminal supports a full-duplex mode; or
capability information of the terminal, wherein the capability information is used to indicate the duplex mode supported by the terminal.

In one embodiment, the terminal may report its own type information to the network side device, wherein the network side device may pre-store the association relationship(s) between the terminal's type information and whether the terminal supports the full-duplex mode. Then, it can be determined whether the terminal supports the full-duplex mode according to the terminal's type information.

For example, type A is associated with the terminal supporting the full-duplex mode, and type B is associated with the terminal not supporting the full-duplex mode. When the indication information received by the network side device is type A, it can be determined that the terminal supports the full-duplex mode. When the indication information received is type B, it can be determined that the terminal does not support the full-duplex mode.

Based on this approach, the terminal can implicitly indicate to the network side device whether the terminal supports the full-duplex mode by reporting the type information of the terminal to the network side device.

In one embodiment, the terminal can explicitly indicate to the network side device the duplex mode supported by the terminal. For example, the capability information can be that the terminal only supports the half-duplex mode, or the terminal only supports the full-duplex mode, or the terminal supports both the half-duplex mode and the full-duplex mode. In addition to this indication method, the terminal can be defaulted to support the half-duplex mode, and on this basis, the capability information indicates whether the terminal supports the full-duplex mode or not.

FIG. 8 is a schematic flowchart of another method for determining a working mode according to an embodiment of the present disclosure. As shown in FIG. 8, the duplex mode information of the terminal includes the duplex mode expected to be adopted for scheduling the terminal by the network side device, and the method further includes the following step:
S801, receiving the indication information during a random access process.

In one embodiment, the terminal may send the indication information to the network side device on appropriate resources as needed. For example, the terminal may send the indication information to the network side device during the random access process. Accordingly, it can be ensured that the network side device can determine the duplex mode information of the terminal during the random access process, so that after the subsequent communication connection is established, the terminal can be scheduled to adopt the appropriate duplex mode as soon as possible, or the duplex mode expected by the terminal can be adopted as soon as possible.

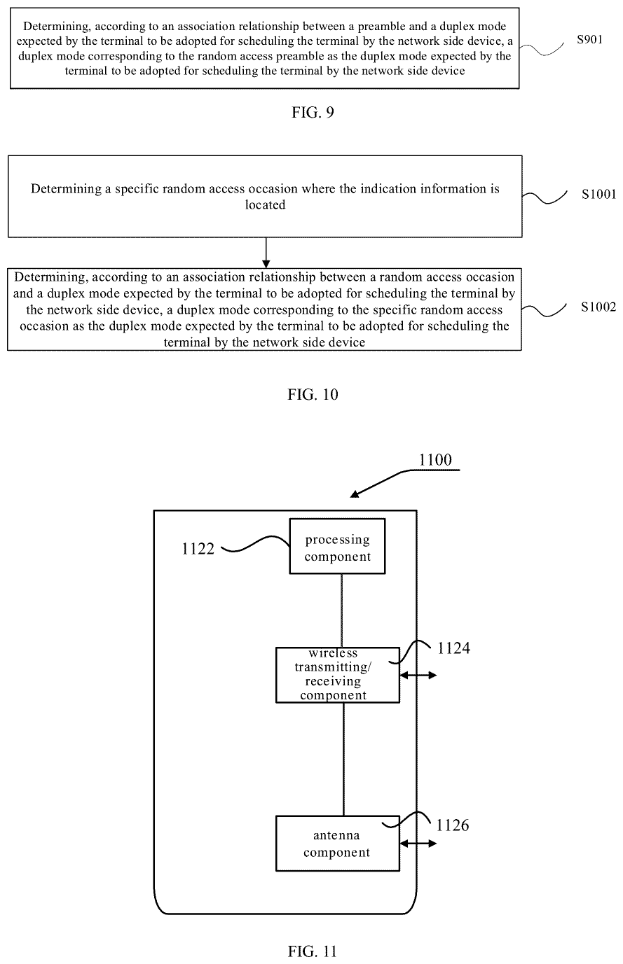

FIG. 9 is a schematic flowchart of yet another method for determining a working mode according to an embodiment of the present disclosure. As shown in FIG. 9, the indication information includes a random access preamble, and determining the duplex mode information of the terminal according to the indication information includes the following step:
S901, determining, according to an association relationship between a preamble and a duplex mode expected by the terminal to be adopted for scheduling the terminal by the network side device, a duplex mode corresponding to the random access preamble as the duplex mode expected by the terminal to be adopted for scheduling the terminal by the network side device.

In one embodiment, the terminal and the network side device may pre-store a first association relationship between a preamble (e.g., a preamble index) and a duplex mode expected by the terminal. After the duplex mode expected by the terminal is determined, the preamble corresponding to the duplex mode expected by the terminal can be determined according to the first association relationship, and then the determined preamble is sent to the network side device. After receiving the preamble sent by the terminal, the network side device can determine the duplex mode expected by the terminal corresponding to the preamble according to the first association relationship.

FIG. 10 is a schematic flowchart of yet another method for determining a working mode according to an embodiment of the present disclosure. As shown in FIG. 10, determining the duplex mode information of the terminal according to the indication information includes the following steps:
S1001, determining a specific random access occasion where the indication information is located; and
S1002, determining, according to an association relationship between a random access occasion and a duplex mode expected by the terminal to be adopted for scheduling the terminal by the network side device, a duplex mode corresponding to the specific random access occasion as the duplex mode expected by the terminal to be adopted for scheduling the terminal by the network side device.

In one embodiment, the terminal and the network side device may pre-store a second association relationship between a random access occasion and a duplex mode expected by the terminal. After the duplex mode expected by the terminal is determined, the specific random access occasion corresponding to the duplex mode expected by the terminal can be determined according to the second association relationship, and then the indication information is sent to the network side device at the specific random access occasion. For example, a random access message serves as the indication information. The network side device receives the random access message sent by the terminal at the specific random access occasion, and can determine the duplex mode expected by the terminal corresponding to the specific random access occasion according to the second association relationship.

In one embodiment, determining the duplex mode information of the terminal according to the indication information includes:
acquiring the indication information from a random access message Msg3 or MsgA sent by the terminal; and
determining a duplex mode indicated by the indication information as the duplex mode expected by the terminal to be adopted for scheduling the terminal by the network side device.

During a four-step random access process, the terminal may carry indication information in the random access message Msg3 and send it to the network side device. During a two-step random access process, the terminal may carry indication information in the random access message MsgA and send it to the network side device.

Corresponding to the foregoing embodiments of the method for indicating the working mode and the method for determining the working mode, the present disclosure also provides embodiments of a device for indicating a working mode and a device for determining a working mode.

The embodiments of the present disclosure provide a device for indicating a working mode, which may be applicable to a terminal including but not limited to a mobile phone, a tablet computer, a wearable device, a sensor, an Internet of Things device and other communication devices. The terminal can communicate with a network side device including but not limited to a network side device in a 4G, 5G, 6G and other communication systems, such as a base station, a core network and the like.

In one embodiment, the device for indicating the working mode includes one or more processors, and the one or more processors are configured to: send indication information to a network side device for indicating duplex mode information of the terminal to the network side device.

In one embodiment, the duplex mode information of the terminal includes at least one of the following:
a duplex mode supported by the terminal;
a duplex mode expected by the terminal to be adopted for scheduling the terminal by the network side device; or
a duplex mode expected by the terminal to be adopted by the network side device.

In one embodiment, the duplex mode information of the terminal includes the duplex mode supported by the terminal, and the one or more processors are configured to: send type information of the terminal to the network side device, wherein the type information is associated with whether the terminal supports a full-duplex mode.

In one embodiment, the duplex mode information of the terminal includes the duplex mode supported by the terminal, and the one or more processors are configured to: send capability information of the terminal to the network side device, wherein the capability information of the terminal is used to indicate the duplex mode supported by the terminal.

In one embodiment, the duplex mode information of the terminal includes the duplex mode expected to be adopted for scheduling the terminal by the network side device, and the one or more processors are configured to: send the indication information to the network side device during a random access process.

In one embodiment, the one or more processors are configured to: send a random access preamble to the network side device, wherein the preamble is associated with the duplex mode expected by the terminal.

In one embodiment, the one or more processors are configured to: send the indication information to the network side device at a specific random access occasion, wherein the specific random access occasion is associated with the duplex mode expected by the terminal.

In one embodiment, the one or more processors are configured to: send a random access message Msg3 or MsgA to the network side device, wherein the random access message carries information associated with the duplex mode expected by the terminal.

The embodiments of the present disclosure provide a device for determining a working mode, which may be applicable to a network side device including but not limited to a network side device in 4G, 5G, 6G and other communication systems, such as a base station, a core network, etc. The network side device can communicate with a terminal, which includes but is not limited to a mobile phone, a tablet computer, a wearable device, a sensor, an Internet of Things device and other communication devices.

In one embodiment, the device for determining the working mode includes one or more processors, and the one or more processors are configured to: determine duplex mode information of a terminal according to at least one of the following:
indication information sent by the terminal;
channel state information sent by the terminal;
a power parameter configured for the terminal; or
interference-related information.

In one embodiment, the duplex mode information of the terminal includes at least one of the following:
a duplex mode supported by the terminal;
a duplex mode expected by the terminal to be adopted for scheduling the terminal by the network side device; or
a duplex mode expected by the terminal to be adopted by the network side device.

In one embodiment, the duplex mode information of the terminal includes the duplex mode supported by the terminal, and the indication information includes at least one of the following:
type information of the terminal, wherein the type information is associated with whether the terminal supports a full-duplex mode; or
capability information of the terminal, wherein the capability information is used to indicate the duplex mode supported by the terminal.

In one embodiment, the duplex mode information of the terminal includes the duplex mode expected by the terminal to be adopted for scheduling the terminal by the network side device, and the one or more processors are further configured to: receive the indication information during a random access process.

In one embodiment, the indication information includes a random access preamble, and the one or more processors are configured to: determine, according to an association relationship between a preamble and a duplex mode expected by the terminal to be adopted for scheduling the terminal by the network side device, a duplex mode corresponding to the random access preamble as the duplex mode expected by the terminal to be adopted for scheduling the terminal by the network side device.

In one embodiment, the one or more processors are configured to: determine a specific random access occasion where the indication information is located; and determine, according to an association relationship between a random access occasion and a duplex mode expected by the terminal to be adopted for scheduling the terminal by the network side device, a duplex mode corresponding to the specific random access occasion as the duplex mode expected by the terminal to be adopted for scheduling the terminal by the network side device.

In one embodiment, the one or more processors are configured to: acquire the indication information from a random access message Msg3 or MsgA sent by the terminal; and determine a duplex mode indicated by the indication information as the duplex mode expected by the terminal to be adopted for scheduling the terminal by the network side device.

In one embodiment, the interference-related information includes at least one of the following:
a transmission power of the network side device;
an antenna configuration of the network side device; or
interference measurement information.

Regarding the devices in the above embodiments, the specific manner in which each module performs operations has been described in detail in the embodiments of the relevant methods, and will not be elaborated here.

For the device embodiments, since they basically correspond to the method embodiments, the relevant parts refer to the partial description of the method embodiments. The device embodiments described above are only schematic, wherein the modules described as separate components may or may not be physically separated, and the components shown as modules may or may not be physical modules, that is, they may be located in one place, or they may be distributed on multiple network modules. Some or all of the modules may be selected according to actual needs to achieve the purpose of the scheme of this embodiment. Those of ordinary skill in the art can understand and implement it without any creative efforts.

The embodiments of the present disclosure further provide a communication device, including: a processor; and a memory for storing a computer program which, when executed by the processor, causes the processor to perform the method for indicating the working mode described in any of the above embodiments.

The embodiments of the present disclosure further provide a communication device, including: a processor; and a memory for storing a computer program which, when executed by the processor, causes the processor to perform the method for determining the working mode described in any of the above embodiments.

The embodiments of the present disclosure further provide a computer-readable storage medium for storing a computer program which, when executed by a processor, causes the processor to perform the steps in the method for indicating the working mode described in any of the above embodiments.

The embodiments of the present disclosure further provide a computer-readable storage medium for storing a computer program which, when executed by a processor, causes the processor to perform the steps in the method for determining the working mode described in any of the above embodiments.

As shown in FIG. 11, FIG. 11 is a schematic block diagram of a device 1100 for determining a working mode according to an embodiment of the present disclosure. The device 1100 may be provided as a base station. Referring to FIG. 11, the device 1100 includes a processing component 1122, a wireless transmitting/receiving component 1124, an antenna component 1126, and a wireless interface-specific signal processing part. The processing component 1122 may further include one or more processors. One of the processors in the processing component 1122 may be configured to perform the method for determining the working mode described in any of the above embodiments.

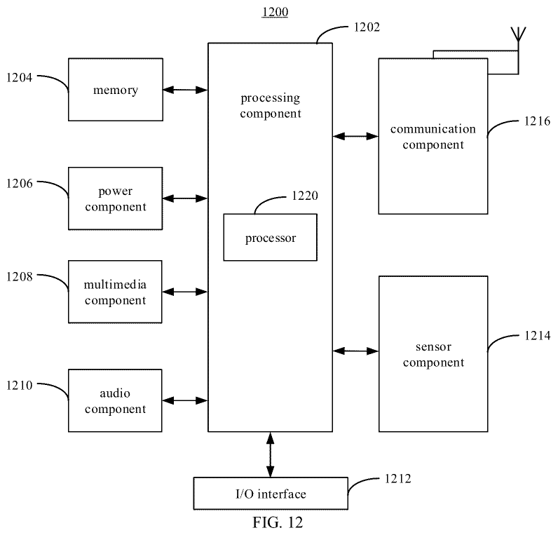

FIG. 12 is a schematic block diagram of a device 1200 for indicating a working mode according to an embodiment of the present disclosure. For example, the device 1200 may be a mobile phone, a computer, a digital broadcast terminal, a message sending and receiving device, a game console, a tablet device, a medical device, a fitness device, a personal digital assistant, etc.

Referring to FIG. 12, the device 1200 may include one or more of the following components: a processing component 1202, a memory 1204, a power component 1206, a multimedia component 1208, an audio component 1210, an input/output (I/O) interface 1212, a sensor component 1214, and a communication component 1216.

The processing component 1202 generally controls the overall operations of the device 1200, such as operations associated with display, phone calls, data communications, camera operations, and recording operations. The processing component 1202 may include one or more processors 1220 to execute instructions to complete all or part of the steps of the above method for indicating the working mode. Additionally, the processing component 1202 may include one or more modules that facilitate interaction between the processing component 1202 and other components. For example, the processing component 1202 may include a multimedia module to facilitate interaction between the multimedia component 1208 and the processing component 1202.

The memory 1204 is configured to store various types of data to support operations on the device 1200. Examples of such data include instructions for any application or method operating on the device 1200, contact data, phone book data, messages, pictures, videos, etc. The memory 1204 can be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk, or optical disk.

The power component 1206 provides power to the various components of the device 1200. The power component 1206 may include a power management system, one or more power supplies, and other components associated with generating, managing, and distributing power for the device 1200.

The multimedia component 1208 includes a screen that provides an output interface between the device 1200 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, swipes, and gestures on the touch panel. The touch sensor may not only sense the boundary of a touch or slide action, but also detect the duration and pressure associated with the touch or slide action. In some embodiments, the multimedia component 1208 includes a front-facing camera and/or a rear-facing camera. When the device 1200 is in an operating mode, such as a shooting mode or a video mode, the front-facing camera and/or the rear-facing camera may receive external multimedia data. Each front-facing camera or rear-facing camera can be a fixed optical lens system or has a focal length and optical zoom capabilities.

The audio component 1210 is configured to output and/or input audio signals. For example, the audio component 1210 includes a microphone (MIC) configured to receive external audio signals when the device 1200 is in operating modes, such as call mode, recording mode, and speech recognition mode. The received audio signals may be further stored in the memory 1204 or sent via the communication component 1216. In some embodiments, the audio component 1210 also includes a speaker for outputting audio signals.

The I/O interface 1212 provides an interface between the processing component 1202 and peripheral interface modules, such as keyboards, click wheels, buttons, etc. These buttons may include, but are not limited to, a home button, a volume button, a start button, and a lock button.

The sensor component 1214 includes one or more sensors for providing various aspects of the status assessment of the device 1200. For example, the sensor component 1214 can detect the open/closed state of the device 1200, the relative positioning of components, such as the display and keypad of the device 1200, the sensor component 1214 can also detect the position change of the device 1200 or a component of the device 1200, the presence or absence of user contact with the device 1200, the orientation or acceleration/deceleration of the device 1200, and the temperature change of the device 1200. The sensor component 1214 can include a proximity sensor configured to detect the presence of a nearby object without any physical contact. The sensor component 1214 can also include an optical sensor, such as a CMOS or CCD image sensor, for use in imaging applications. In some embodiments, the sensor component 1214 can also include an acceleration sensor, a gyroscope sensor, a magnetic sensor, a pressure sensor, or a temperature sensor.

The communication component 1216 is configured to facilitate wired or wireless communication between the device 1200 and other devices. The device 1200 can access a wireless network based on a communication standard, such as Wi-Fi, 2G, 3G, 4G LTE, 5G NR, or a combination thereof. In one exemplary embodiment, the communication component 1216 receives broadcast signals or broadcast related information from an external broadcast management system via a broadcast channel. In one exemplary embodiment, the communication component 1216 also includes a near field communication (NFC) module to facilitate short-range communications. For example, the NFC module can be implemented based on radio frequency identification (RFID) technology, infrared data association (IrDA) technology, ultra-wideband (UWB) technology, Bluetooth® (BT) technology and other technologies.

In an exemplary embodiment, the device 1200 may be implemented by one or more application specific integrated circuits (ASICs), digital signal processors (DSPs), digital signal processing devices (DSPDs), programmable logic devices (PLDs), field programmable gate array (FPGA), controller, microcontroller, microprocessor or other electronic components for executing the above method for indicating the working mode.

In an exemplary embodiment, a non-transitory computer-readable storage medium including instructions is also provided, such as the memory 1204 including instructions, and the instructions can be executed by the processor 1220 of the device 1200 to complete the above method for indicating the working mode. For example, the non-transitory computer-readable storage medium can be a ROM, a random access memory (RAM), a CD-ROM, a magnetic tape, a floppy disk, an optical data storage device, etc.

Other embodiments of the disclosure will be readily apparent to those skilled in the art from consideration of the specification and practice of the disclosure herein. The present disclosure is intended to cover any variations, uses, or adaptations of the disclosure that follow the general principles of the disclosure and include common sense or customary technical means in the technical field that are not disclosed herein. It is intended that the specification and examples be considered as exemplary only, with a true scope and spirit of the disclosure being indicated by the following claims.

It is to be understood that the present disclosure is not limited to the precise structures described above and illustrated in the accompanying drawings, and various modifications and changes may be made without departing from the scope thereof. The scope of the disclosure is limited only by the appended claims.

It should be noted that in this document, relational terms such as “first” and “second” are used only to distinguish one entity or operation from another, and do not necessarily require or imply any such actual relationship or order between the entities or operations. The terms “includes”, “comprises”, or any other variant thereof, are intended to cover non- exclusive inclusion, so that a process, method, article or device including a set of elements includes not only those elements, but also other elements not expressly listed, or may also include elements that are inherent to such a process, method, article or device. Without further limitation, the elements defined by the phrase “including a . . . ” do not exclude the presence of additional identical elements in the process, method, article, or device that includes said elements.

The methods and devices provided by the embodiments of the present disclosure have been introduced in detail above. Specific examples are used in this document to illustrate the principles and implementations of the present disclosure. The description of the above embodiments is only used to assist in understanding the methods and core idea of this disclosure. Meanwhile, for those of ordinary skill in the art, there may be changes in the specific implementation and application scope based on the ideas of this disclosure. In summary, the content of this specification should not be understood as a limitation of this disclosure.

1. A method for indicating a working mode, performed by a terminal, the method comprising:
sending indication information to a network side device for indicating duplex mode information of the terminal to the network side device.

2. The method of claim 1, wherein the duplex mode information of the terminal comprises at least one of:
a duplex mode supported by the terminal;
a duplex mode expected by the terminal to be adopted for scheduling the terminal by the network side device; or
a duplex mode expected by the terminal to be adopted by the network side device.

3. The method of claim 2, wherein the duplex mode information of the terminal comprises the duplex mode supported by the terminal, and sending the indication information to the network side device comprises:
sending type information of the terminal to the network side device, wherein the type information is associated with whether the terminal supports a full-duplex mode.

4. The method of claim 2, wherein the duplex mode information of the terminal comprises the duplex mode supported by the terminal, and sending the indication information to the network side device comprises:
sending capability information of the terminal to the network side device, wherein the capability information of the terminal is used to indicate the duplex mode supported by the terminal.

5. The method of claim 2, wherein the duplex mode information of the terminal comprises the duplex mode expected to be adopted for scheduling the terminal by the network side device, and sending the indication information to the network side device comprises:
sending the indication information to the network side device during a random access process.

6. The method of claim 5, wherein sending the indication information to the network side device during the random access process comprises:
sending a random access preamble to the network side device, wherein the preamble is associated with the duplex mode expected by the terminal.

7. The method of claim 5, wherein sending the indication information to the network side device during the random access process comprises:
sending the indication information to the network side device at a specific random access occasion, wherein the specific random access occasion is associated with the duplex mode expected by the terminal.

8. The method of claim 5, wherein sending the indication information to the network side device during the random access process comprises:
sending a random access message Msg3 or MsgA to the network side device, wherein the random access message carries information associated with the duplex mode expected by the terminal.

9. A method for determining a working mode, performed by a network side device, the method comprising:
determining duplex mode information of a terminal according to at least one of:
indication information sent by the terminal;
channel state information sent by the terminal;
a power parameter configured for the terminal; or
interference-related information.

10. The method of claim 9, wherein the duplex mode information of the terminal comprises at least one of:
a duplex mode supported by the terminal;
a duplex mode expected by the terminal to be adopted for scheduling the terminal by the network side device; or
a duplex mode expected by the terminal to be adopted by the network side device.

11. The method of claim 10, wherein the duplex mode information of the terminal comprises the duplex mode supported by the terminal, and the indication information comprises at least one of:
type information of the terminal, wherein the type information is associated with whether the terminal supports a full-duplex mode; or
capability information of the terminal, wherein the capability information is used to indicate the duplex mode supported by the terminal.

12. The method of claim 10, wherein the duplex mode information of the terminal comprises the duplex mode expected by the terminal to be adopted for scheduling the terminal by the network side device, and the method further comprises:
receiving the indication information during a random access process.

13. The method of claim 12, wherein the indication information comprises a random access preamble, and determining the duplex mode information of the terminal according to the indication information comprises:
determining, according to an association relationship between a preamble and a duplex mode expected by the terminal to be adopted for scheduling the terminal by the network side device, a duplex mode corresponding to the random access preamble as the duplex mode expected by the terminal to be adopted for scheduling the terminal by the network side device.

14. The method of claim 12, wherein determining the duplex mode information of the terminal according to the indication information comprises:
determining a specific random access occasion where the indication information is located; and
determining, according to an association relationship between a random access occasion and a duplex mode expected by the terminal to be adopted for scheduling the terminal by the network side device, a duplex mode corresponding to the specific random access occasion as the duplex mode expected by the terminal to be adopted for scheduling the terminal by the network side device.

15. The method of claim 12, wherein determining the duplex mode information of the terminal according to the indication information comprises:
acquiring the indication information from a random access message Msg3 or MsgA sent by the terminal; and
determining a duplex mode indicated by the indication information as the duplex mode expected by the terminal to be adopted for scheduling the terminal by the network side device.

16. The method of claim 9, wherein the interference-related information comprises at least one of:
a transmission power of the network side device;
an antenna configuration of the network side device; or
interference measurement information.

17. (canceled)

18. (canceled)

19. A communication device, comprising:
a processor; and
memory for storing a computer program;
wherein the computer program, when executed by the processor, causes the processor to perform the method for indicating the working mode of claim 1.

20. A communication device, comprising:
a processor;
memory for storing a computer program;
wherein the computer program, when executed by the processor, causes the processor to perform the method for determining the working mode of claim 9.

21. A non-transitory computer-readable storage medium for storing a computer program which, when executed by a processor, causes the processor to perform steps in the method for indicating the working mode of claim 1.

22. A non-transitory computer-readable storage medium for storing a computer program which, when executed by a processor, causes the processor to perform steps in the method for determining the working mode of claim 9.
